(19) United States
(12) Patent Application Publication
(10) Pub. No.: US 2011/0028107 A1
(43) Pub. Date: Feb. 3, 2011

(54) SPECTRUM SENSING NETWORK

(76) Inventors: Gokhan Memik, Evanston, IL (US); Seda Ogrenci Memik, Evanston, IL (US); Bill Mangione-Smith, Kirkland, WA (US)

Correspondence Address: EVAN LAW GROUP LLC, 600 WEST JACKSON BLVD., SUITE 625, CHICAGO, IL, 60661, US

(21) Appl. No.: 12/511,962

(22) Filed: Jul. 29, 2009

(51) Int. Cl. H04B 1/04

(52) U.S. Cl. 455/114.2

(57) ABSTRACT

In accordance with various embodiments methods, systems and devices are generally described for assigning a reputation value to a cognitive device in a communications system. Some of the described methods may include one or more of generating reputation value information, assigning a reputation value associated with the cognitive device, based on the reputation value information, and transmitting the reputation value associated with the cognitive device, to the cognitive radio. In addition, some other described methods may include one or more of associating a reputation value with the cognitive device, receiving cognitive information from the cognitive device, and performing a cognitive task using the cognitive information based on the reputation value exceeding a threshold value.

### REFERENCE To RELATED APPLICATIONS

This application is related to the following co-pending applications, application Ser. No. ______ (Attorney Docket No. LLV01-004-US) entitled “Location and Time Sensing Cognitive Radio Communication Systems” filed ______; application Ser. No. ______ (Attorney Docket No. VCS01-005-US) entitled “Spectrum Sensing Network For Cognitive Radios” filed ______; application Ser. No. ______ entitled “Secure Cognitive Radio Transmissions” (Attorney Docket No. BCV01-007-US) filed ______; application Ser. No. ______ (Attorney Docket No. UHV01-008-US) entitled “Cognitive Radios For Secure Transmissions” filed ______; and application Ser. No. ______ (Attorney Docket No. FDV01-009-US) entitled “Spectrum Sensing Network For Cognitive Radios” filed ______.

### BACKGROUND

The electromagnetic radio spectrum is a natural resource, the use of which by transmitters and receivers is licensed by governments. In many bands, spectrum access is a more significant problem than physical scarcity of spectrum, in large part due to legacy command-and-control regulation that limits the ability of potential spectrum users to obtain such access. Indeed, if portions of the radio spectrum were scanned, including in the revenue-rich urban areas, one would find that some frequency bands in the spectrum are largely unoccupied most of the time; some other frequency bands are only partially occupied; and the remaining frequency bands are heavily used.

The underutilization of the electromagnetic spectrum has lead to the view that spectrum holes within the electromagnetic spectrum may exist. As used herein, a spectrum hole exists when a band of frequencies assigned to a primary user is not being utilized by that user, at a particular time and specific geographic location. By making it possible for a secondary user to access the band of frequencies within a spectrum hole, utilization of the electromagnetic spectrum may be improved. A cognitive radio, inclusive of software-defined radio, has been proposed as a means to promote the efficient use of the electromagnetic spectrum by exploiting the existence of spectrum holes.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts a cognitive radio;

FIG. 2 depicts a schematic representation of a communications system;

FIG. 3 depicts a flowchart illustration of methods, apparatus (systems) and computer program products;

FIG. 4 depicts a flowchart illustration of methods, apparatus (systems) and computer program products; and

FIG. 5 depicts a flowchart illustration of methods, apparatus (systems) and computer program products, all arranged in accordance with at least some embodiments of the present disclosure.

### DETAILED DESCRIPTION

The following description sets forth various examples along with specific details to provide a thorough understanding of claimed subject matter. However, it will be understood by those skilled in the art that claimed subject matter may be practiced without some or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and computer program products related to cognitive devices. The present disclosure may make use of the discovery that by offloading some of the cognitive tasks performed by a cognitive radio within a portable communications device to a cognitive radio within a cognitive device, which is coupled to a constant power source, the amount of power required to operate the portable communications device may be minimized. Additionally, by assigning a reputation value to a cognitive device, the reliability and accuracy of information received from the cognitive device may be determined, and a determination may be made as to whether that information may be used or not.

As used herein, the phrase “cognitive task” may include one or more of (1) radio-scene analysis, (2) estimating interference temperature (a metric which quantifies sources of interference in a radio environment), (3) detecting spectrum holes, by spectrum sensing, (4) channel identification, (5) estimation of channel-state information, (6) prediction of channel capacity for use by the transmitter, (7) transmit-power control, and/or (8) dynamic spectrum management. As used herein, the phrase “cognitive device” may include a device which may be configured to carry out cognitive tasks, such as a cognitive radio, or a cognitive receiver. As used herein, the phrase “cognitive information” may include information that may be used to assist in carrying out a cognitive task. As used herein, the phrase “cognitive instruction” may include an instruction that may help assist in accomplishing a cognitive task.

In some embodiments, a cognitive device is described that may include, a cognitive receiver configured to process a cognitive task and a communications device including a cognitive radio with a processor arranged in communication with the cognitive receiver. An initial reputation value can be assigned to the cognitive device.

In some additional embodiments, a cognitive device is described that may be arranged to process cognitive tasks for a communications device having a cognitive radio. The example cognitive device may include a cognitive receiver, an antenna, and/or a communications port. The example cognitive receiver may be arranged to process a cognitive task and produce cognitive information upon processing the cognitive task. The antenna may be adapted to receive radio frequency signals from the cognitive receiver. The communications port may be arranged to communicate with the communications device. The communications port may be configured to communicate the cognitive information to the communications device. The cognitive receiver may include a processor arranged in communication with memory. A reputation value may be stored in the memory.

In yet other examples embodiments, methods to assign a reputation value to a cognitive device may be described. The methods may include receiving, in a communications device, cognitive information from the cognitive device, determining the accuracy of the cognitive information, and transmitting reputation value information to a processor.

In still additional example embodiments, methods to communicate in a communications system may include processing a cognitive task with a cognitive receiver. Example methods may further include receiving, in a communications device, a reputation value of the cognitive device, and determining whether to use cognitive information from the cognitive device based at least upon the reputation value.

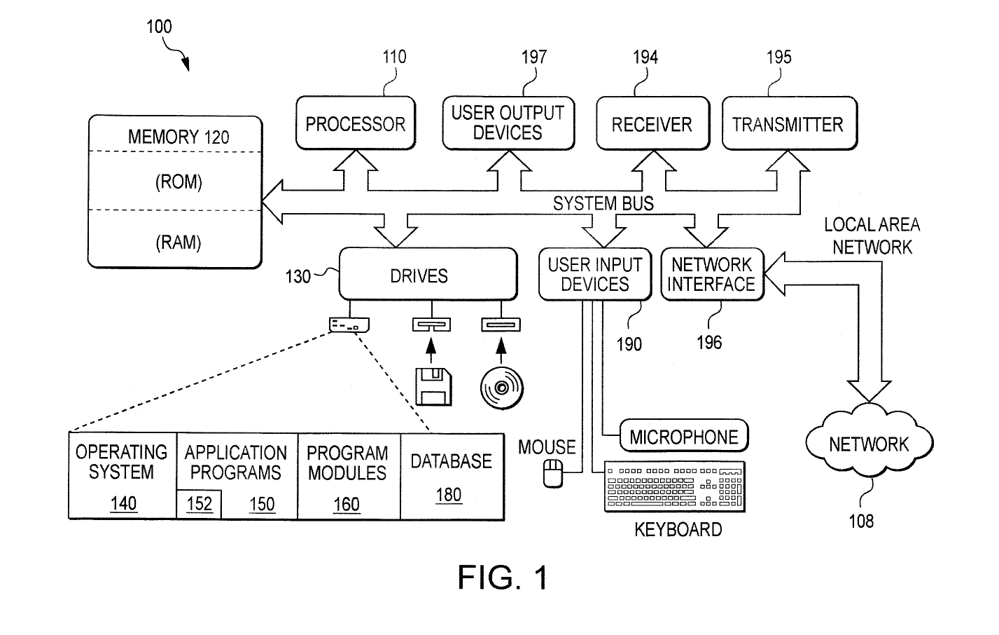

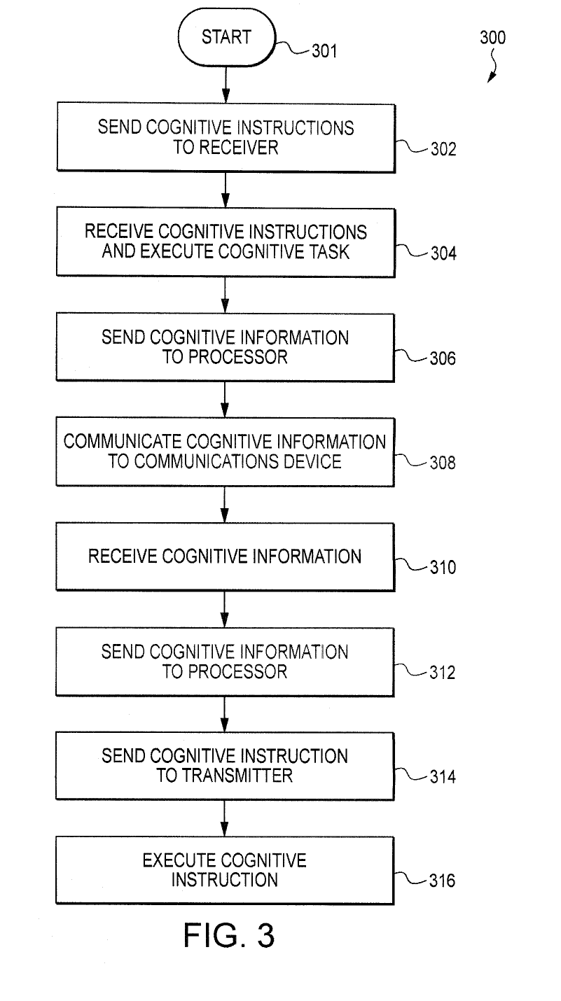

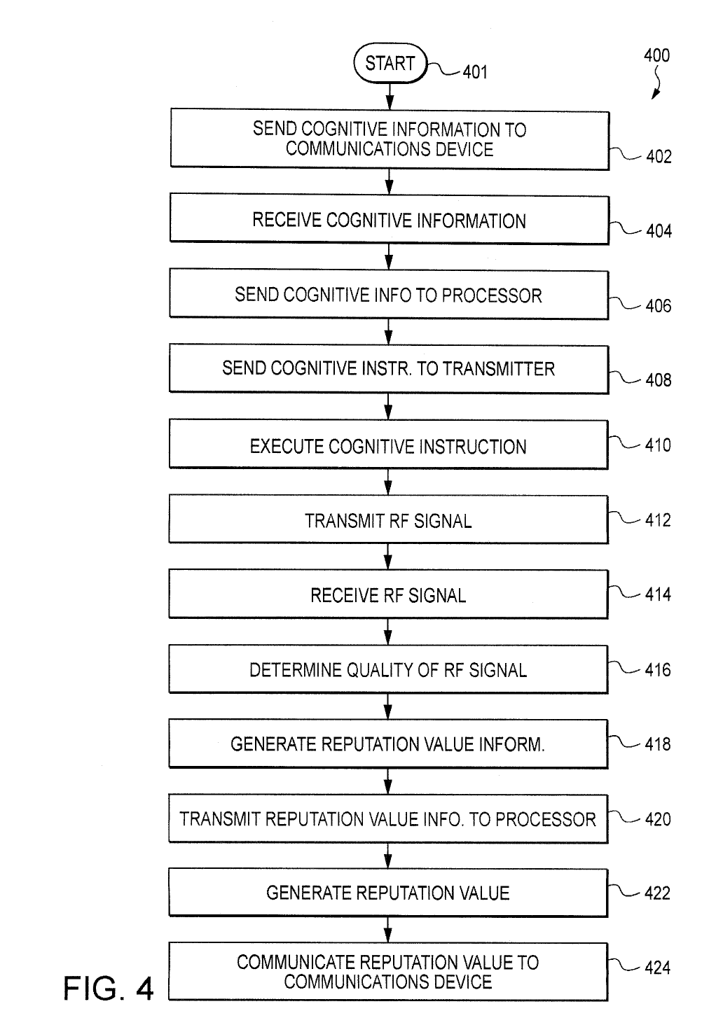

FIG. 1 depicts a cognitive radio in accordance with at least some embodiments of the present disclosure. As shown in FIG. 1, a cognitive radio 100, may include a processor 110, a memory 120 and one or more drives 130. The drives 130 and their associated computer storage media may be arranged to provide storage of computer readable instructions, data structures, program modules and other data for the cognitive radio 100. Drives 130 can include stored there on one or more of an operating system 140, application programs 150, program modules 160, and/or a database 180. Application programs 150, for example, may include an application program containing program instructions for causing a cognitive radio 100 to carry out the functions and/or processes specified in FIGS. 3, 4 and/or 5, for example a method to generate and assign a reputation value 152. Cognitive radio 100 may further include user input devices 190 through which a user may enter commands and/or data. Example input devices can include one or more of an electronic digitizer, a microphone, a keyboard and/or a pointing device, commonly referred to as a mouse, trackball or touch pad. Other example input devices may include a joystick, game pad, satellite dish, scanner, or the like.

These and other input devices can be connected to processor 110 through a user input interface that is coupled to a system bus, but may be connected by other interface and bus structures, such as a parallel port, game port or a universal serial bus (USB). Cognitive radio 100 may also includes a receiver 194 through which radio frequency signals may be received and a transmitter 195 through which radio frequency signals may be transmitted. Cognitive radio 100 with receiver 194 and without transmitter 195 may be referred to herein as a cognitive receiver, and cognitive radio 100 with transmitter 195 and without receiver 194 may be referred to herein as a cognitive transmitter. In some embodiments, the cognitive radio 100 may include a transceiver, instead of receiver 194 and transmitter 195, wherein the transceiver may operate as both a transmitter and a receiver.

Cognitive radio 100 may operate in a networking environment using connections to one or more computers, such as a remote computer connected to network interface 196. The remote computer may be a personal computer (PC), a server, a router, a network PC, a peer device or other common network node, and can include some or all of the elements described above relative to cognitive radio 100. Example networking environments that are commonplace in offices may include enterprise-wide area networks (WAN), local area networks (LAN), intranets and world-wide networks such as the Internet or World Wide Web.

For example, cognitive radio 100 may be the source from which data is being migrated, and the remote computer may be the destination to which the data is being migrated, or vice versa. Note however, that the source and destination need not be connected by a network 108 or any other means, but instead data may be migrated via any media capable of being written by the source and read by the destination. When used in a LAN or WAN networking environment, cognitive radio 100 may be connected to the LAN through a network interface 196 or an adapter. When used in a WAN networking environment, cognitive radio 100 typically may include a modem or other means for establishing communications over the WAN, such as the Internet or network 108. It will be appreciated that other means of establishing a communications link between the source and destination may be used. Cognitive radio 100 may also be connected to user output devices 197 for outputting information to a user. Example user output devices 197 may include one or more of a display, a printer and/or speakers.

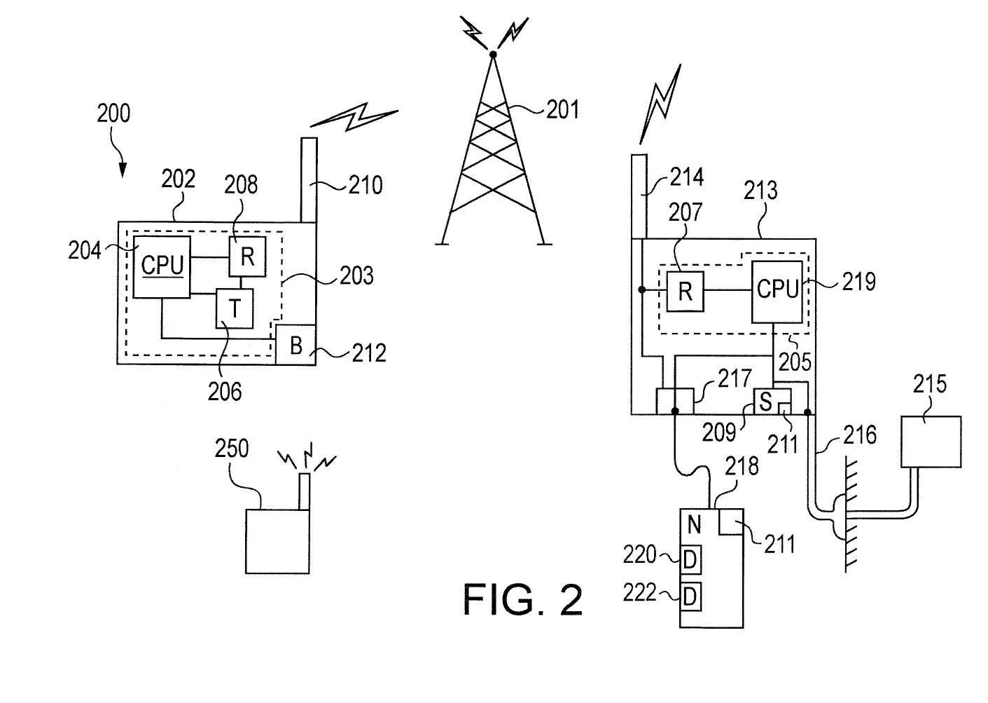

FIG. 2 depicts a schematic representation of a communications system arranged in accordance with at least some embodiments of the present disclosure. As shown in FIG. 2, a communications system 200 may be provided. The communications system 200 may include a communications device 202 that may be arranged in communication with one or more of a cognitive device 213, a transmission tower 201, and/or another communications device 250.

The communications device 202 may be a device that may be arranged to transmit or receive RF signals, and may be, for example, a wireless telephone, a radio, a hand-held two-way radio transceiver, or the like. The communications device 202 may include a cognitive radio 203, an antenna 210, and a power source 212. The cognitive radio 203 may be a wireless communication device that may be adapted to change its transmission or reception parameters to communicate efficiently and avoid interference with licensed or unlicensed users of other communications devices (e.g., communications device 250). The cognitive radio 203 may be arranged to perform cognitive tasks, which may include the alteration of parameters based on the active monitoring of several factors in the external and/or internal radio environment, such as, for example, radio frequency spectrum, user behavior and/or network state. The cognitive tasks performed by cognitive radio 203 may begin with the passive sensing of RF stimuli, called spectrum sensing. The following are examples of other optional cognitive tasks that may be performed by cognitive radio 203: (1) radio-scene analysis, which may encompass: (1)(a) estimating interference temperature (a metric which quantifies sources of interference in a radio environment); and (1)(b) detecting spectrum holes, by spectrum sensing; (2) channel identification, which may encompass: (2)(a) estimation of channel-state information; and (2)(b) prediction of channel capacity for use by the transmitter; and (3) transmit-power control and/or dynamic spectrum management.

Cognitive radio 203 functionally may include all or some of the components of cognitive radio 100, as described above for FIG. 1. Cognitive radio 203 may also include at least a processor 204 arranged in communication with a receiver 208 and optionally a transmitter 206. In some examples, transmitter 206 and receiver 208 may be replaced with a transceiver. Processor 204 may be configured to send cognitive instructions to both the receiver 208 and transmitter 206 and may receive cognitive information, such as spectrum sensing information, from the receiver 208 when performing and processing cognitive tasks, such as spectrum sensing.

In some examples, a cognitive task of spectrum sensing may be utilized to detect spectrum holes, which may be bands of unused radio frequencies in the radio frequency (RF) spectrum available for use by cognitive radio 203. The cognitive radio 203 and/or cognitive receiver 205 may be adapted to passively sense the RF spectrum and estimate the power spectra of incoming radio frequency stimuli, in order to classify the RF spectrum into one of three broadly defined types of radio frequencies. Although this disclosure is not limited to only three defined types of radio frequencies, example defined types of radio frequencies may include: (1) black spaces, which are occupied by high-power “local” interferers some of the time; (2) grey spaces, which are partially occupied by low-power interferers; and/or (3) white spaces, which are free of RF interferers except for ambient noise, made up of natural and artificial forms of noise. Examples of ambient noise may include: broadband thermal noise produced by external physical phenomena such as solar radiation; transient reflections from lightening, plasma (fluorescent) lights, and aircraft; impulsive noise produced by ignitions, commutators, and microwave appliances; and thermal noise due to internal spontaneous fluctuations of electrons at the front end of individual receivers.

White spaces and grey spaces, to a lesser extent, may contain spectrum holes which make good candidates for use by cognitive radio 203. While black spaces are to be avoided when and where the RF emitters residing in them are switched ON, when those emitters are switched OFF, the black spaces assume a new role of “spectrum holes.” The cognitive radio 203 and/or cognitive receiver 205 provide the opportunity for discovering significant “white spaces” within the unused black spaces by invoking a dynamic-coordination capability for spectrum sharing.

In some examples, by conducting the cognitive task of spectrum sensing, cognitive radio 203 may be able to determine which portion of the RF spectrum contains frequencies that are not being utilized, identifying spectrum holes. Thereafter, receiver 208 within cognitive radio 203 and/or cognitive receiver 205 may communicate spectrum sensing information that contains information regarding spectrum holes, to processor 204 within cognitive radio 203. The spectrum sensing information may typically contain bands of frequencies within the white spaces and the grey spaces, however sometimes the bands of frequencies may be within the black spaces. Examples of cognitive radios are described in: Haykin, S. “Cognitive Radio: Brain-Empowered Wireless Communications,” IEEE JOURNAL ON SELECTED AREAS IN COMMUNICATIONS, Vol. 23, No. 2, pp. 201-220 (February 2005).

Upon conducting the cognitive task of spectrum sensing and also determining which portion of the RF spectrum contains frequencies which may not be utilized (or available), receiver 208 within cognitive radio 203 may communicate spectrum sensing information to processor 204 within cognitive radio 203. The spectrum sensing information may contain information about spectrum holes. The spectrum sensing information may also contain bands of frequencies that may be within the white spaces and the grey spaces, or the bands of frequencies that may be within the black spaces.

In some embodiments, when performing a cognitive task of spectrum sensing, the processor 204 may be arranged to send cognitive instructions to the receiver 208 such that the receiver 208 is instructed to scan the RF spectrum for spectrum holes. The receiver 208 may be configured to send spectrum sensing information to the processor 204 to inform the processor 204 of spectrum holes (i.e., receiver 208 may inform the processor 204 which bands of RF frequencies may be available for use). The processor 204 may be configured to send cognitive instructions to the transmitter 206 which may be adapted to transmit at a radio frequency available for use, or within one of the spectrum holes.

Receiver 208 may be arranged to receive RF signals, either digital or analog, from antenna 210 and transmitter 206 may be configured to transmit RF signals through antenna 210. Antenna 210 may be arranged to transmit or receive RF signals to/from transmission tower 201. Transmission tower 201 may be arranged to broadcast these RF signals, for example via land lines or other RF signals. Transmission tower 201 may transmit to other communications devices, such as communications device 250 or telephones. Transmission tower 201 may transmit to other communication devices including wired or wireless devices. Antenna 210 may be used to send RF signals to and receive signals from other communications devices 250 and cognitive device 213.

Power source 212 may be in arranged in communication with and may power cognitive radio 203. Power source 212 may be a portable device such as, for example, a battery, a fuel cell, a lithium ion battery, or a capacitor.

Cognitive tasks, such as spectrum sensing, may require the detection of spectrum holes and their subsequent exploitation in the management of radio spectrum, which may be time consuming and may use significant power. By offloading some cognitive tasks from cognitive radio 203 to another device, such as cognitive device 213, the amount of electrical and computational power used by communications device 202 may be reduced. The amount of time required to perform cognitive tasks within the communications device 202 may also be reduced.

Cognitive device 213 may include a cognitive receiver 205 that is arranged to process cognitive tasks, an antenna 214 configured to receive radio frequency signals, and a communications port 217. Cognitive device 213 may be arranged in communication with communications device 202 through a variety of means, such as, wired or wireless communications. Example wired communications may include USB, Firewire, and network cabling such as CAT-5 or fiber optic cable. Example wireless communications may include Bluetooth, Wi-Fi, WiMax, EDGE (Enhanced Data rates for GSM Evolution), GSM (Global System for Mobile communications), GPRS (General packet radio service), 3G, 4G, CDMA (Code division multiple access), or any other communications protocol which may transmit RF signals. In a LAN or WAN networking environment, cognitive device 213 may be adapted to communicate with communications device 202 through a network interface 196 (FIG. 1) or an adapter. In a WAN networking environment, cognitive device 213 may be adapted to communicate through a modem or other means for establishing communications over the WAN, such as the Internet or network 108 (FIG. 1). Other means of establishing a communications link between the cognitive device 213 and the communications device 202 may also be used.

The cognitive receiver 205 may be implemented as a wireless communication device that may be adapted to change its reception parameters to communicate efficiently and avoid interference with licensed or unlicensed users of other communications devices (e.g., communications device 250). The cognitive receiver 205 may be arranged to perform cognitive tasks, which may include the alteration of parameters based on the active monitoring of several factors in the external and internal radio environment, such as radio frequency spectrum, user behavior and network state. Example cognitive tasks performed by cognitive receiver 205 may begin with the passive sensing of RF stimuli, called spectrum sensing, and an action may follow. The following examples of cognitive tasks may be performed by cognitive receiver 205: (1) radio-scene analysis, which may encompass: (1)(a) estimating interference temperature (a metric which quantifies sources of interference in a radio environment); and (1)(b) detecting spectrum holes, by spectrum sensing; (2) channel identification, which may encompass: (2)(a) estimation of channel-state information; and (2)(b) prediction of channel capacity for use by the transmitter.

Cognitive receiver 205 may include all the components of cognitive radio 100, as described above for FIG. 1. Cognitive receiver 205 may also include at least a processor 219 that may be arranged in communication with a receiver 207. Processor 219 may be arranged to send cognitive instructions to the receiver 207 and may be adapted to receive cognitive information from the receiver 207 when performing and processing cognitive tasks, such as spectrum sensing.

In some examples, when performing a cognitive task of spectrum sensing, the processor 219 may be configured to send cognitive instructions to the receiver 207 such that the receiver 207 is instructed to scan the RF spectrum for spectrum holes. The receiver 207 may be arranged to send spectrum sensing information to the processor 219 to inform the processor 219 of spectrum holes (i.e., receiver 207 may inform the processor 219 which bands of RF frequencies may be available for use). The process of sending spectrum sensing information to the processor 219 to inform the processor 219 of spectrum holes may be repeated multiple times for different parts of the RF spectrum. The processor 219 may be configured to send the cognitive information through the communications port 217 to the communications device 202, which may be adapted to receive the cognitive information through antenna 210 and forward the cognitive information to processor 204. Processor 204 may be arranged to instruct the transmitter 206 to transmit at a radio frequency that may be available for use, or within one of the spectrum holes. In this manner, cognitive receiver 205 may be configured to perform certain cognitive tasks that would otherwise be performed by cognitive radio 203. In doing so, cognitive receiver 205 may be able to reduce the amount of electrical and/or processing power used by cognitive radio 203. This may allow communications device 202 to be able to operate with a less powerful processor 204, a lower capacity power source 212, and/or to possibly operate for longer durations.

Communications port 217 may be arranged in communication with the communications device 202 and may communicate cognitive information to communications device 202. Communications port 217 may be in communication with the communications device 202 through a network 218. Communications port 217 may also be arranged to directly communicate with communications device 202 through antenna 214, and may be arranged to communicate cognitive information directly to communications device 202. Network 218 may be arranged in communication with both communications device 202 and cognitive device 213, for example, via a wired or wireless connection.

Receiver 207 may be configured to receive RF signals, either digital or analog, from antenna 214. Antenna 214 may be adapted to transmit or receive RF signals to/from transmission tower 201. Antenna 214 may broadcast these RF signals, for example via land lines or other RF signals. Antenna 214 may transmit to other communications devices, such as communications devices 202, 250 or telephones. Antenna 214 may transmit to other communications devices including wired or wireless devices.

Cognitive device 213 may include a power source 216 that may be configured in communication with and power cognitive receiver 205. Power source 216 may include a power connector that may be configured to connect with a stationary power source 215, such as a power generating plant. In this manner, cognitive device 213 may be adapted to use a nearly limitless supply of power in order to process cognitive tasks, which may otherwise be processed by communications device 202.

In some embodiments, a reputation value 211 may assigned to each cognitive device 213 in the communications system 200. The reputation value 211 may be stored in network 218, internally in the cognitive device 213, or internally in the communications device 202 or communications device 250, as illustrated in FIG. 2.

In some embodiments, the reputation value 211 may be stored internally in the cognitive device 213. The cognitive device 213 may include a storage device 209 arranged in communication with the processor 219. The storage device 209 may include any device which may store binary data and may be a memory device including, for example, RAM, ROM, or Flash Memory, a magnetic storage device including, for example, flexible disks or hard disk drives, or optical storage devices including, for example, CD-ROM or DVD-ROM disks. The storage device 209 may be configured to store the reputation value 211. Whether stored in network 218 or internally in the cognitive device 213, the reputation value 211 may be stored such that it may be accessible by the communications device 202, for example, via wireless communication or via a wired communication.

Reputation value 211 may represent the overall reliability and accuracy of the cognitive information generated by the cognitive device 213. The reputation value 211 may be generated by the cognitive device 213, based at least in part on the accuracy of information received by the receiver 207. Additionally, the reputation value 211 may be generated based at least in part on information received by communications device 202, other communications devices (e.g., communications device 250), or by information which is publicly accessible. Reputation value 211 may also be generated by communications device 202, or other communications device 250. The reputation value may be based at least in part on the accuracy of information received by communications device 202, or other communications device 250. Furthermore, the reputation value may be based on the accuracy of information which is publicly accessible, or the accuracy of information from receiver 208 or a receiver in communications device 250. Reputation value 211 may include one or more of the following pieces of information: (1) information on historic reliability of data collected by the cognitive device 213, (2) information on reliability of a manufacturer of the cognitive device 213, (3) information on location of the cognitive device 213, (4) information on a level of protection or security available to the cognitive device 213, or (5) information on a prior determination that the cognitive device 213 is malicious.

Information on historic reliability of data collected by the cognitive device 213 may be generated over time by the cognitive device 213 and may be based at least in part on the accuracy of the cognitive information generated by the receiver 207. The accuracy of the cognitive information generated by the receiver 207 may be tested by either the cognitive device 213 or by communication device 202, and reputation value information may be generated in return. For example, communications device 202 may be arranged to receive cognitive information from the cognitive device 213 and may be configured to operate its transmitter 206 and receiver 208 based on the cognitive information. Depending at least in part on the quality of the RF signals received and transmitted by the communications device 202, the accuracy of the cognitive information may be determined. The quality of the RF signals received and transmitted by the communications device 202 may be determined by feedback between the receiver 208, the transmitter 206, the transmission tower 201, and other communications devices (e.g., communications device 250). Upon determining the accuracy of the cognitive information, communications device 202 may generate reputation value information that may rate the reliability of the cognitive information generated by the cognitive device 213, and may transmit the reputation value information to the network 218 or the cognitive device 213, either one of which may compile this information and use it to generate a reputation value 211. Additionally, reputation value information may be transmitted to the cognitive device 213, for example, via communications device 202 or network 218, and may be received by communications port 217. Over time, the reputation value information may be collected by the network 218 or the cognitive device 213, and may be used to build information on historic reliability of data collected by the cognitive device 213 which may be used to generate the reputation value 211 for the cognitive device 213.

Information on reliability of a manufacturer of the cognitive device 213 may be generated by determining information on the manufacturer of a specific cognitive device and associating the manufacturer information and the reputation value information received for a particular cognitive device 213. Over time, a database 220 may be built on network 218 which may include the manufacturer information along with the reputation value information associated with that particular manufacturer, resulting in information on reliability of a manufacturer of the cognitive device 213. When generating the reputation value 211, the information on reliability of a manufacturer of the cognitive device 213 may be retrieved from the database 220 stored on network 218 by, for example, looking up the manufacturer associated with a particular cognitive device 213, and using the information on reliability of a manufacturer of the cognitive device 213 when generating the reputation value 211. The database 220 may update the information on reliability of a manufacturer (in some examples, continuously) when receiving the manufacturer information along with all the reputation value information associated with that particular manufacturer from a variety of communications devices 202 based at least in part on their experiences with a particular cognitive device 213.

Information on location of the cognitive device 213 may be generated by determining the specific location of the cognitive device, using a Global Position System, for example, and associating the location information along with the reputation value information received for a particular cognitive device 213. Over time, a database 222 may be built, on network 218 or on storage 209, which may include the location information and the reputation value information associated with that particular location, resulting in information on location of the cognitive device 213. When generating the reputation value 211, the information on location of the cognitive device 213 may then be retrieved and then used to generate reputation value 211. The database 222 may be arranged to update the information (in some examples, continuously) on location of the cognitive device 213 when receiving the location information and the reputation value information associated with that particular cognitive device 213.

Information on the level of protection or security available to the cognitive device 213 may be generated by, for example, determining the amount of protection from malicious software or hacking found within a particular cognitive device. Alternatively or in addition, information on the level of protection or security available may be generated by determining what security software and/or hardware are within a particular cognitive device 213. Upon generating the information on level of protection or security available to the cognitive device 213, the information may then be stored in network 218 or in storage 209. When generating the reputation value 211, information on level of protection of the cognitive device 213 may then be retrieved and then used to generate reputation value 211.

A prior determination that the cognitive device 213 may be malicious may be generated by communications device 200 upon a determination that it may contain malicious software or may be trying to hack the communications device 200. Upon a determination that the cognitive device 213 may be malicious, the information may be stored in network 218 or in storage 209. When generating the reputation value 211, information on a prior determination that the cognitive device 213 may be malicious may be retrieved and used to generate reputation value 211.

Additionally, the reputation value 211 may vary based at least in part on the location of the cognitive device 213 relative to the communications device 202. For example, if communications device 202 is far way from cognitive device 213, then the reputation value 211 for the cognitive device may be determined to be low. Similarly, if communications device 202 is near cognitive device 213, then the reputation value 211 for the cognitive device may be determined to be high. A high reputation value 211 may represent a high amount of reliability and accuracy of the cognitive information generated by the cognitive device 213, while a low reputation value 211 may represent a low amount of reliability and accuracy of the cognitive information generated by the cognitive device 213.

FIGS. 3-5 are flowchart illustrations of methods, which can be carried out by an apparatus or systems, for example under instructions from a computer program product, according to at least some embodiments of the present disclosure. It will be understood that each block of the flowchart illustrations in FIGS. 3-5, and combinations of blocks in the flowchart illustrations in FIGS. 3-5, can be implemented by computer program instructions. These computer program instructions may be loaded onto a computer or other programmable data processing apparatus to produce a machine, such that the instructions which execute on the computer or other programmable data processing apparatus are means for implementing the functions specified in the flowchart block or blocks. These computer program instructions may also be stored in a storage device that can direct a computer or other programmable data processing apparatus to function in a particular manner, such that the instructions stored in the storage device are an article of manufacture including instruction which implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions which execute on the computer or other programmable apparatus implement the functions specified in the flowchart block or blocks.

Accordingly, blocks of the flowchart illustrations in FIGS. 3-5 support combinations of means for performing the specified functions, combinations of steps for performing the specified functions and program instruction means for performing the specified functions. It will also be understood that each block of the flowchart illustrations in FIGS. 3-5, and combinations of blocks in the flowchart illustrations in FIGS. 3-5, can be implemented by special purpose hardware-based computer systems, such as a cognitive radio, which perform the specified functions or steps, or combinations of special purpose hardware and computer instructions.

Such computer instructions may be fixed either on a tangible medium, such as a computer readable medium (for example, a diskette, CD-ROM, ROM, or fixed disk) or transmittable to a computer system, via a modem or other interface device, such as a communications adapter connected to a network over a medium. The medium may be either a tangible medium (for example, optical or analog communications lines) or a medium implemented with wireless techniques (for example, microwave, infrared or other transmission techniques). The series of computer instructions embodies all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (for example, shrink wrapped software), preloaded with a computer system (for example, on system ROM or fixed disk), or distributed from a server or electronic bulletin board over the network (for example, the Internet or World Wide Web).

FIG. 3 depicts a flowchart illustration of methods, apparatus (systems) and computer program products, in accordance with at least some embodiments of the present disclosure. With reference to FIG. 3 example operations of cognitive device 213 in conjunction with communications device 202 will be described. A method 300 for processing a cognitive task for a communications device having a cognitive radio, such as communications device 202, may be initiated at block 301. Upon initiating the method 300 for processing a cognitive task at block 301, processor 219 may be arranged to send cognitive instructions to the receiver 207 at block 302. The cognitive instructions may be any instruction that helps in accomplishing a cognitive task. At block 304, the receiver 207 may be adapted to receive the cognitive instructions and begin to execute a cognitive task, such as spectrum sensing, which may cause the receiver 207 to scan the RF spectrum for spectrum holes.

After initiating the cognitive task, the receiver 207 may then be configured to send cognitive information to the processor 219, at block 306. For example, the receiver 207 may be configured to send spectrum sensing information to the processor 219 to inform the processor 219 of spectrum holes (i.e., the receiver may inform the processor 219 which bands of RF frequencies may be available for use). The processor 219 may be arranged to communicate the cognitive information to the communications device 202, at block 308. For example, the processor 219 may be arranged to communicate spectrum sensing information to the communications device 202. The cognitive information may be communicated directly to the communications device 202 through antenna 214, or indirectly through a network 218 coupled to communications port 217.

At block 310, communications device 202 may be configured to receive the cognitive information from cognitive device 213. At block 312, the communications device 202 may be configured to send the cognitive information to processor 204. Processor 204 may be configured to send cognitive instructions to the transmitter 206 at block 314. The transmitter 206 may be arranged to execute the cognitive instructions at block 316. The cognitive instructions may include instructions that assist in accomplishing a cognitive task. For example, the cognitive instructions sent by processor 204 to transmitter 206 may be adapted to instruct the transmitter 206 to transmit at a radio frequency that may be available for use, or within one of the spectrum holes.

FIG. 4 depicts a flowchart illustration of methods, apparatus (systems) and computer program products, in accordance with embodiments of the present disclosure. With reference to FIG. 4, example generation and assignment of one or more reputation values to example cognitive device 213 will be described. A method 400 to generate and assign a reputation value 211 to a cognitive device 213, may be initiated at block 401. Upon initiating the method 400 at block 401, cognitive device 213 may be arranged to send cognitive information to communications device 202 at block 402. The cognitive information may be communicated directly to the communications device 202 through antenna 214, or indirectly through a network 218 coupled to communications port 217.

At block 404, communications device 202 may be configured to receive the cognitive information from cognitive device 213. At block 406, the communications device 202 may be configured to send the cognitive information to processor 204. Processor 204 may be arranged to send cognitive instructions to the transmitter 206 at block 408. The transmitter 206 may be arranged to execute the cognitive instructions at block 410. The cognitive instructions may be any instruction that assist in accomplishing a cognitive task. For example, the cognitive instructions sent by processor 204 to transmitter 206 may be adapted to instruct the transmitter 206 to transmit at a radio frequency that may be available for use, or within one of the spectrum holes. Transmitter 206 may be configured to transmit an RF signal at block 412. The RF signal may be received by transmission tower 201, another communications device 250, receiver 208, or receiver 207, at block 414. The quality of the RF signals received and transmitted by the communications device 202 may be determined by either a receiver, such as a receiver within the transmission tower 201, a receiver within another communications device 250, receiver 208, or receiver 207, at block 416. Information regarding the quality of the RF signals received may be relayed to a processor for generating reputation value information which may rate the reliability of the cognitive information generated by the cognitive device 213, at block 418. The processor may include any device which may process binary information, such as processor 204, processor 219, or any processor in communication with network 218. At block 420, the reputation value information may be transmitted to a processor in communication with network 218, cognitive device 213, or any communications device 202, 250, which may be arranged to generate a reputation value 211 based at least in part on the received information, at block 422. The reputation value 211 may be associated with the cognitive device 213 and may be communicated to a communications device 202 which may use cognitive device 213, at block 424. In this manner, a communications device 202 which may use cognitive device 213 may be adapted to determine the accuracy of the cognitive information generated by the cognitive device 213.

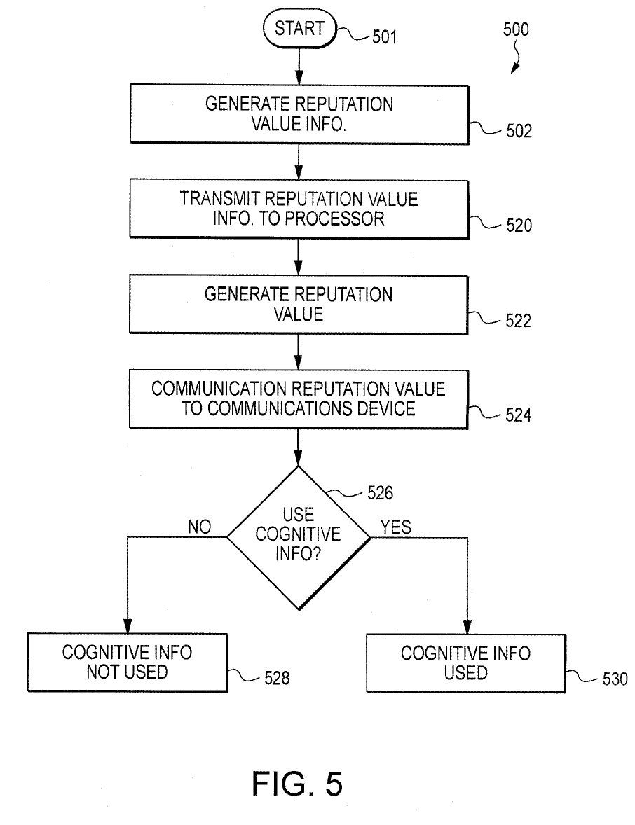

FIG. 5 depicts a flowchart illustration of methods, apparatus (systems) and computer program products, in accordance with embodiments of the present disclosure. With reference to FIG. 5, example generation and assignment of a reputation values to example cognitive device 213 will be described. A method 500 to generate and assign a reputation value 211 to a cognitive device 213, may be initiated at block 501. Upon initiating the method 500 at block 501, reputation value information may be generated at block 502, for example: by determining the quality of RF signals received and transmitted by the communications device 202; by determining the manufacturer of a specific cognitive device 213; by determining the location of cognitive device 213; by determining the level of protection or security available to a cognitive device 213; and/or by determining any known property of the cognitive device 213. Properties of the cognitive device 213 may include, for example: the manufacturer of the cognitive device 213; the level of protection or security that the cognitive device 213 has with respect to malicious software and/or hacking; the location of the cognitive device 213; the date of manufacture of the cognitive device 213; the type of software run on the cognitive device 213; and/or the components within the cognitive device 213.

At block 520, the reputation value information may be transmitted to a processor in communication with network 218, the cognitive device 213, or any communications device 202, 250, which may be arranged to generate a reputation value 211 based at least in part on the received information, at block 522. The reputation value 211 may be associated with the cognitive device 213 and communicated to any communications device 202 which may use cognitive device 213, at block 524. Any communications device 202 which may use cognitive device 213 may be arranged to determine the accuracy of the cognitive information generated by the cognitive device 213.

The communications device 202 may configured to determine whether to use cognitive information from the cognitive device 213 based at least on the reputation value 211, at block 526. In an example, if the reputation value 211 is determined to be at a level that is too low (e.g., below a threshold value), the communications device 202 may refuse to use cognitive information from the cognitive device 213, as shown at block 528. If the reputation value 211 is determined to be at a high enough value (e.g., exceeds a threshold value), the communications device 202 may use cognitive information from the cognitive device 213, as shown at block 530.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been described, it will be apparent to those of ordinary skill in the art that other embodiments and implementations are possible within the scope of the embodiments. Accordingly, the subject matter disclosed is not to be restricted except in light of the attached claims and their equivalents.

1. A method for assigning a reputation value to a cognitive device in a communications system including a cognitive radio, the method for the cognitive device comprising:
generating reputation value information;
assigning a reputation value associated with the cognitive device, based on the reputation value information; and
transmitting the reputation value associated with the cognitive device, to the cognitive radio.

2. The method of claim 1, wherein the reputation value information is generated from, at least in part, historic reliability of data collected by the cognitive device.

3. The method of claim 1, wherein the reputation value information is generated from, at least in part, one or more of a reliability associated with a manufacturer of the cognitive device, a location associated with the cognitive device, and a level of protection associated with the cognitive device.

4. The method of claim 1, further comprising changing the reputation value when the cognition device is determined to have been moved from a first location to a second location.

5. The method of claim 1, further comprising:
collecting reliability data; and
changing the reputation value based on the reliability data collected.

6. A method for performing a cognitive task with a cognitive radio in a communications system including a cognitive device, the method for the cognitive radio comprising:
associating a reputation value with the cognitive device;
receiving cognitive information from the cognitive device; and
performing a cognitive task using the cognitive information based on the reputation value exceeding a threshold value.

7. The method of claim 6, wherein the reputation value information is determined at least in part by a prior determination that the cognitive device is malicious.

8. The method of claim 6, wherein the reputation value is received from the cognitive device.

9. The method of claim 8, wherein the reputation value information is determined at least in part by historic reliability of data collected by the cognitive device.

10. The method of claim 8, wherein the reputation value information is determined at least in part by one or more of a reliability associated with a manufacturer of the cognitive device, a location associated with the cognitive device, or a level of protection associated with the cognitive device.

11. The method of claim 8, further comprising changing the reputation value when the cognition device is determined to have been moved from a first location to a second location.

12. A computer program product comprising software encoded in a computer-readable media, for assigning a reputation value to a cognitive device in a communications system including a cognitive radio, the software comprising instructions, operable when executed, to:
generate reputation value information;
assign a reputation value associated with the cognitive device, based on the reputation value information; and
transmit the reputation value associated with the cognitive device, to the cognitive radio.

13. The computer program product of claim 12, wherein the instructions to generate the reputation value information comprises instructions to generate the reputation value information from, at least in part, historic reliability of data collected by the cognitive device.

14. The computer program product of claim 12, wherein the instructions to generate the reputation value information comprises instructions to generate the reputation value information from, at least in part, one or more of a reliability associated with a manufacturer of the cognitive device, a location associated with the cognitive device, and a level of protection associated with the cognitive device.

15. The computer program product of claim 12, wherein the software further comprises instructions, operable when executed, to change the reputation value when the cognition device is determined to have been moved from a first location to a second location.

16. A computer program product comprising software encoded in a computer-readable media, for performing a cognitive task with a cognitive radio in a communications system including a cognitive device, the software comprising instructions, operable when executed, to:
associate a reputation value with the cognitive device;
receive cognitive information from the cognitive device; and
perform a cognitive task using the cognitive information based on the reputation value exceeding a threshold value.

17. The computer program product of claim 16, wherein the reputation value information is determined at least in part by a prior determination that the cognitive device is malicious.

18. The computer program product of claim 16, wherein the software further comprises instructions, operable when executed, to receive the reputation value from the cognitive device.

19. The computer program product of claim 18, wherein the reputation value information is determined at least in part by historic reliability of data collected by the cognitive device.

20. The computer program product of claim 18, wherein the reputation value information is determined at least in part by one or more of a reliability associated with a manufacturer of the cognitive device, a location associated with the cognitive device, or a level of protection associated with the cognitive device.
